(19) United States
(12) Patent Application Publication
(10) Pub. No.: US 2025/0190398 A1
(43) Pub. Date: Jun. 12, 2025

(54) DATA MANAGEMENT METHOD AND DATA MANAGEMENT SYSTEM

(71) Applicant: SEIKO EPSON CORPORATION, Tokyo (JP)

(72) Inventors: Takayuki SHIMIZU, SHIOJIRI-SHI (JP); Sachio TSUBOI, MATSUMOTO-SHI (JP)

(21) Appl. No.: 18/971,322

(22) Filed: Dec. 6, 2024

(30) Foreign Application Priority Data
Dec. 6, 2023 (JP) 2023-206443

(51) Int. Cl. G06F 16/13; G06F 16/11

(52) U.S. Cl. CPC G06F 16/13; G06F 16/122

(57) ABSTRACT

A data management method includes: a first PJ owned by a first user who resides in a first area transmitting, to a second DB server device disposed in a second area, first data, which is data not including personal information of the first user among information output by the first PJ, and specific correspondence information associated with the first PJ; the second DB server device storing the first data and the specific correspondence information in association with each other; and a first AP server device disposed in the first area acquiring the first data from the second DB server device using the specific correspondence information.

The present application is based on, and claims priority from JP Application Serial Number 2023-206443, filed Dec. 6, 2023, the disclosure of which is hereby incorporated by reference herein in its entirety.

### BACKGROUND

### 1. Technical Field

The present disclosure relates to a data management method and a data management system.

### 2. Related Art

In related art, there has been known a technique for managing personal information.

For example, JP-A-2022-146426 discloses an information processing device that stores country information indicating a country or community of a user, and controls to, when a document that may include personal information from a user is to be stored, refer to the country information of the user and determine a server for storing the document.

JP-A-2022-146426 is an example of the related art.

According to the technique described in JP-A-2022-146426, personal information of a user can be prevented from leaking out of a country or community where the user resides when saving data. In the following description, “data leaking out of a country or community where a user resides” is referred to as “data crossing border”.

Here, when collecting data that does not directly correspond to personal information but can indirectly specify an individual, data that can only indirectly specify an individual is subjected to data crossing border without specifying the individual, whereby data can be effectively used.

However, in the technique described in JP-A-2022-146426, when there is a possibility that output data from an electronic device includes personal information, the output data from the electronic device is collectively to be saved in a country or community where the user resides, and therefore the output data cannot be subjected to data crossing border.

### SUMMARY

One aspect of the present disclosure is a data management method including: application server device disposed in a first region causing a first file server device disposed in the first region to store personal information of a first user who resides in the first region and association data, which is associated with a first electronic device owned by the first user, in association with each other; the first electronic device storing the association data; the first electronic device transmitting, to a second file server device disposed in a second region different from the first region, the association data and first data which is data not including the personal information of the first user and indicating a state of the first electronic device among information output by the first electronic device; the second file server device storing the first data and the association data in association with each other; and the first application server device acquiring the first data from the second file server device using the association data.

Another aspect of the present disclosure is a data management system including: a first file server device configured to store personal information of a first user who resides in a first region and association data, which is associated with a first electronic device owned by the first user, in association with each other; a second file server device disposed in a second region different from the first region and configured to store the association data and first data in association with each other, the first data being data not including the personal information of the first user and indicating a state of the first electronic device among information output by the first electronic device; and a first application server device configured to acquire the first data from the second file server device using the association data.

### BRIEF DESCRIPTION OF THE DRAWINGS

FIG. 1 is a diagram showing an example of a configuration of a data management system according to an embodiment.

FIG. 2 is a diagram showing an example of a sequence of user registration in a first AP server device.

FIG. 3 is a diagram showing an example of a sequence in which a PC acquires first data.

FIG. 4 is a diagram showing an example of a sequence in which the PC acquires second data.

FIG. 5 is a chart showing an example of information output by an electronic device.

### DESCRIPTION OF EMBODIMENTS

An embodiment is described below with reference to the drawings.

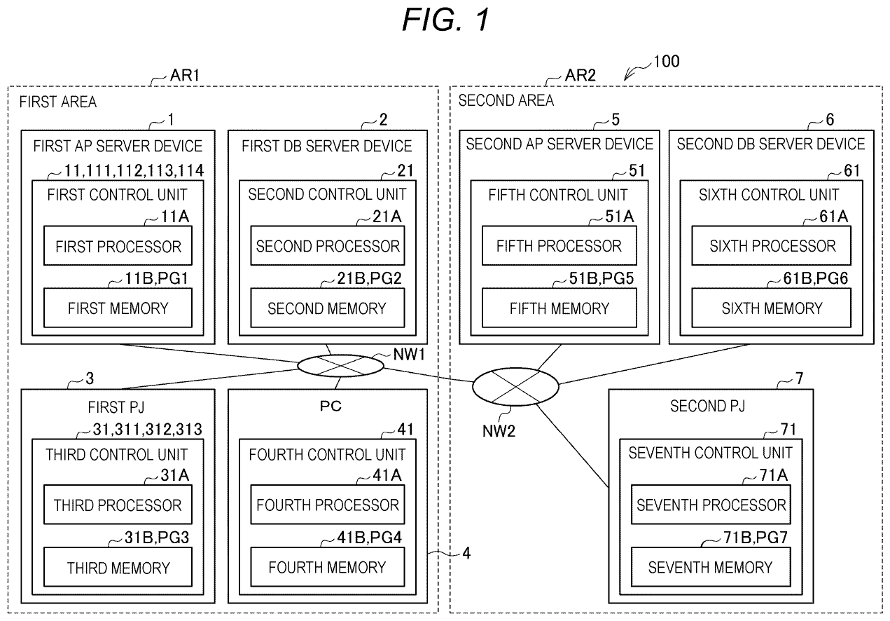

FIG. 1 is a diagram showing an example of a configuration of a data management system 100 according to the present embodiment. The data management system 100 includes a first application server device 1, a first database server device 2, a first projector 3, a personal computer 4, a second application server device 5, a second database server device 6, and a second projector 7.

The first application server device 1, the first database server device 2, the first projector 3, and the personal computer 4 are disposed in a first area AR1.

The first application server device 1, the first database server device 2, the first projector 3, and the personal computer 4 are communicably connected via a first network NW1.

The first area AR1 corresponds to an example of a “first region”. In the present embodiment, the “first region” means “first country” or “first community”. In other words, in the present embodiment, the “region” means “country or community”.

The first network NW1 is, for example, a part of the Internet. In other words, the first network NW1 is a network of the Internet disposed in the first area AR1.

The second application server device 5, the second database server device 6, and the second projector 7 are disposed in a second area AR2 different from the first area AR1.

The second application server device 5, the second database server device 6, and the second projector 7 are communicably connected via a second network NW2.

The second area AR2 corresponds to an example of a “second region”. In the present embodiment, the “second region” means “second country” or “second community”.

The second network NW2 is, for example, a part of the Internet. In other words, the second network NW2 is a network of the Internet disposed in the second area AR2.

The second network NW2 is communicably connected to the first network NW1.

Since the second network NW2 is communicably connected to the first network NW1, each of the first application server device 1, the first database server device 2, the first projector 3, and the personal computer 4 disposed in the first area AR1 and each of the second application server device 5, the second database server device 6, and the second projector 7 disposed in the second area AR2 are communicably connected to each other.

In the present embodiment, a case will be described in which the first network NW1 and the second network NW2 are each a part of the Internet, but the embodiment is not limited thereto. Each of the first network NW1 and the second network NW2 may be, for example, a wide area network (WAN).

The first database server device 2 corresponds to an example of a “first file server device”.

The second database server device 6 corresponds to an example of a “second file server device”.

The first projector 3 corresponds to an example of a “first electronic device”.

The second projector 7 corresponds to an example of a “second electronic device”.

The personal computer 4 corresponds to an example of a “terminal device”.

In the following description, for convenience, the first application server device 1 may be referred to as the “first AP server device 1”, and the second application server device 5 may be referred to as the “second AP server device 5”. The first database server device 2 may be referred to as the “first DB server device 2”, and the second database server device 6 may be referred to as the “second DB server device 6”. The first projector 3 may be referred to as the “first PJ 3”, and the second projector 7 may be referred to as the “second PJ 7”. The personal computer 4 may be referred to as the “PC 4”.

Next, configurations of the first AP server device 1, the first DB server device 2, the first PJ 3, the PC 4, the second AP server device 5, the second DB server device 6, and the second PJ 7 will be described with reference to FIG. 1.

First, the configuration of the first AP server device 1 will be described.

The first AP server device 1 is disposed in the first area AR1 and provides a first user U1 with various services related to information output by the first PJ 3. The first user U1 is a user who resides in the first area AR1 and owns the first PJ 3 and the PC 4.

The first AP server device 1 includes a first control unit 11. The first control unit 11 controls each unit of the first AP server device 1. The first control unit 11 includes a first processor 11A and a first memory 11B.

The first memory 11B is a storage device that stores a program to be executed by the first processor 11A and data in a nonvolatile manner. The first memory 11B includes a magnetic storage device, a semiconductor storage element such as a flash read only memory (ROM), or a nonvolatile storage device of another type. The first memory 11B may also include a random access memory (RAM) constituting a work area of the first processor 11A. The first memory 11B stores data to be processed by the first control unit 11, a first control program PG1 to be executed by the first processor 11A, and the like.

The first processor 11A may be implemented by a single processor, or a plurality of processors may function as the first processor 11A. The first processor 11A executes the first control program PG1 to control each unit of the first AP server device 1.

The first processor 11A may be implemented by a System on Chip (SoC) integrated with part or all of the first memory 11B and other circuits. The first processor 11A may be implemented by a combination of a central processing unit (CPU) that executes a program and a digital signal processor (DSP) that executes predetermined arithmetic processing. All of the functions of the first processor 11A may be implemented in hardware or may be implemented using a programmable device.

In the following description, a case will be described in which the first processor 11A reads out and executes the first control program PG1 stored in the first memory 11B to control each unit of the first AP server device 1.

The first control unit 11 functions as a storage instruction unit 111, a first acquisition unit 112, a second acquisition unit 113, and a transmission execution unit 114. Specifically, the first processor 11A reads out and executes the first control program PG1 stored in the first memory 11B to function as the storage instruction unit 111, the first acquisition unit 112, the second acquisition unit 113, and the transmission execution unit 114.

The storage instruction unit 111 causes the first DB server device 2 to store personal information of the first user U1 in association with specific correspondence information DP.

The first user U1 is a user who resides in the first area AR1. The first user U1 is a user who owns and uses the first PJ 3. The first user U1 is a user who owns the PC 4.

The specific correspondence information DP is data associated with the first PJ 3 and is information that does not correspond to personal information of a user such as the first user U1.

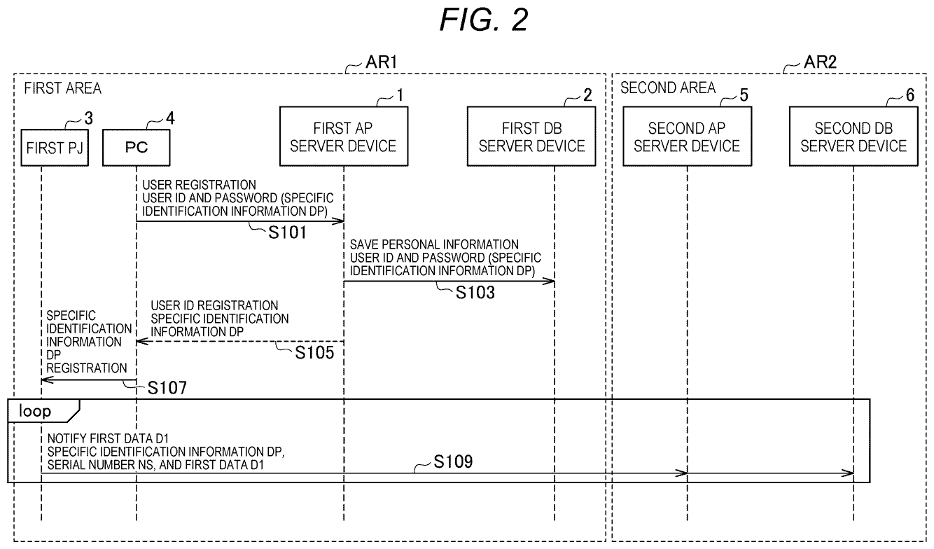

The specific correspondence information DP is information associated with, for example, a corporation such as a stock company or an individual that owns the first PJ 3. As described with reference to FIG. 2, when the first user U1 performs user registration for the first PJ 3, the first control unit 11 generates a random number and assigns the generated random number as the specific correspondence information DP.

As described above, since the specific correspondence information DP is the random number generated by the first control unit 11, the specific correspondence information DP is not considered to be personal information under the law regarding protection of personal information in the first area AR1. Therefore, by using the specific correspondence information DP, for example, the first acquisition unit 112 can acquire first data D1 from the second DB server device 6 disposed in the second area AR2.

The specific correspondence information DP corresponds to an example of “association data”.

The first acquisition unit 112 acquires the first data D1 from the second DB server device 6 using the specific correspondence information DP.

The first data D1 is data not including the personal information of the first user U1 and indicating a state of the first PJ 3 among information output by the first PJ 3. The first data D1 includes, for example, data such as a light source usage time, input source resolution, and an error history in the first PJ 3.

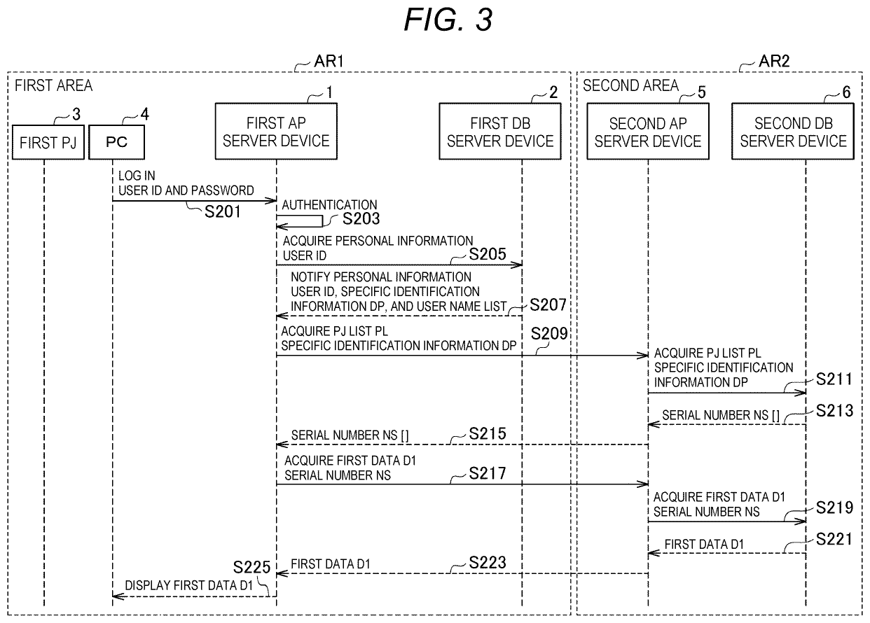

Processing by the first acquisition unit 112 will be further described with reference to FIG. 3.

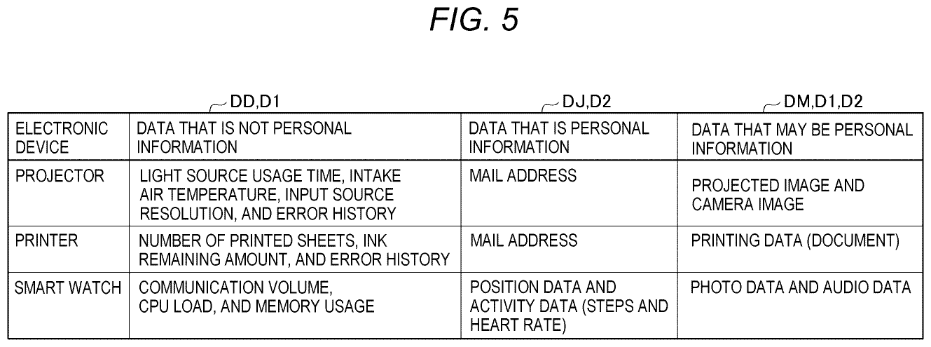

The first data D1 is further described with reference to FIG. 5.

The second acquisition unit 113 acquires second data D2 from the first PJ 3. The second data D2 is data excluding the first data D1 and including the personal information of the first user U1 among the information output by the first PJ 3.

The second data D2 includes at least a part of setting information of the first PJ 3. The second data D2 also includes at least a part of image information of the first PJ 3.

The second data D2 is set, for example, based on the law regarding protection of personal information in the first area AR1. In other words, the second data D2 is information that is or may be protected by the law regarding protection of personal information in the first area AR1. The second data D2 includes, for example, data such as a user ID and password used to authenticate the first user U1 in the first AP server device 1, a mail address of the first PJ 3, and an image taken by a camera provided in the first PJ 3.

The reason why the image taken by the camera provided in the first PJ 3 is subject to protection of personal information is that the taken image may include an image of a user such as the first user U1.

The second data D2 is further described with reference to FIG. 5.

The storage instruction unit 111 causes the first DB server device 2 to store first transmission destination information indicating a first transmission destination R1 which is a transmission destination to which the first PJ 3 transmits the second data D2 and included in the first area AR1. For example, in response to a request from the PC 4, the storage instruction unit 111 causes the first DB server device 2 to store the first transmission destination information indicating the first transmission destination R1 which is a transmission destination to which the first PJ 3 transmits the second data D2. In this case, the first transmission destination R1 is the PC 4, and the first transmission destination information is mail address information of the PC 4.

The transmission execution unit 114 transmits the second data D2 acquired by the second acquisition unit 113 to the first DB server device 2 in association with the specific correspondence information DP.

The storage instruction unit 111 causes the first DB server device 2 to store the second data D2 in association with the specific correspondence information DP.

Next, the configuration of the first DB server device 2 will be described.

The first DB server device 2 stores the second data D2 in association with the specific correspondence information DP in accordance with an instruction from the first AP server device 1.

The first DB server device 2 includes a second control unit 21. The second control unit 21 controls each unit of the first DB server device 2. The second control unit 21 includes a second processor 21A and a second memory 21B.

The second memory 21B is a storage device that stores a program to be executed by the second processor 21A and data in a nonvolatile manner. The second memory 21B includes a magnetic storage device, a semiconductor storage element such as a flash ROM, or a nonvolatile storage device of another type. The second memory 21B may include a RAM constituting a work area of the second processor 21A. The second memory 21B stores data to be processed by the second control unit 21, a second control program PG2 to be executed by the second processor 21A, and the like.

The second processor 21A may be implemented by a single processor, or a plurality of processors may function as the second processor 21A. The second processor 21A executes the second control program PG2 to control each unit of the first DB server device 2.

The second processor 21A may be implemented by an SoC integrated with part or all of the second memory 21B and other circuits. The second processor 21A may include a combination of a CPU executing a program and a DSP executing predetermined arithmetic processing. All of the functions of the second processor 21A may be implemented in hardware or may be implemented using a programmable device.

In the following description, a case will be described in which the second processor 21A reads out and executes the second control program PG2 stored in the second memory 21B to control each unit of the first DB server device 2.

The second control unit 21 stores the personal information of the first user U1 in association with the specific correspondence information DP in accordance with an instruction from the storage instruction unit 111 of the first AP server device 1.

The second control unit 21 receives the second data D2 transmitted by the transmission execution unit 114 of the first AP server device 1 and the specific correspondence information DP.

Then, the second control unit 21 stores the second data D2 in association with the specific correspondence information DP in accordance with the instruction from the storage instruction unit 111 of the first AP server device 1.

The second control unit 21 receives the first transmission destination information transmitted by the transmission execution unit 114 of the first AP server device 1. The first transmission destination information indicates the first transmission destination R1 which is a transmission destination to which the first PJ 3 transmits the second data D2. The first transmission destination R1 is, for example, the PC 4, and the first transmission destination information is mail address information of the PC 4.

The second control unit 21 transmits the first transmission destination information to the first PJ 3 in response to a request from the first PJ 3.

Next, the configuration of the first PJ 3 will be described.

The first PJ 3 acquires a projection image from a source device (not shown), and projects the projection image onto a projection surface such as a screen. The first PJ 3 includes a camera (not shown), and takes, by the camera, an image of the projection surface onto which the projection image is projected.

The first PJ 3 includes a third control unit 31. The third control unit 31 controls each unit of the first PJ 3. The third control unit 31 includes a third processor 31A and a third memory 31B.

The third memory 31B is a storage device that stores a program to be executed by the third processor 31A and data in a nonvolatile manner. The third memory 31B includes a magnetic storage device, a semiconductor storage element such as a flash ROM, or a nonvolatile storage device of another type. The third memory 31B may include a RAM constituting a work area of the third processor 31A. The third memory 31B stores data to be processed by the third control unit 31, a third control program PG3 to be executed by the third processor 31A, and the like.

The third processor 31A may be implemented by a single processor, or a plurality of processors may function as the third processor 31A. The third processor 31A executes the third control program PG3 to control each unit of the first PJ 3.

The third processor 31A may be implemented by an SoC integrated with part or all of the third memory 31B and other circuits. The third processor 31A may include a combination of a CPU executing a program and a DSP executing predetermined arithmetic processing. All of the functions of the third processor 31A may be implemented in hardware or may be implemented using a programmable device.

In the following description, a case will be described in which the third processor 31A reads out and executes the third control program PG3 stored in the third memory 31B to control each unit of the first PJ 3.

The third control unit 31 functions as a first transmission unit 311, a second transmission unit 312, and a third transmission unit 313. Specifically, the third processor 31A reads out and executes the third control program PG3 stored in the third memory 31B to function as the first transmission unit 311, the second transmission unit 312, and the third transmission unit 313.

The first transmission unit 311 transmits the first data D1 and the specific correspondence information DP to the second DB server device 6. The first data D1 is data not including the personal information of the first user U1 and indicating a state of the first PJ 3 among the information output by the first PJ 3.

For example, the first transmission unit 311 transmits the first data D1 and the specific correspondence information DP to the second DB server device 6 via the second AP server device 5.

The second transmission unit 312 transmits the second data D2 to the first transmission destination R1 based on the first transmission destination information acquired from the first DB server device 2. The first transmission destination information indicates the first transmission destination R1.

In other words, for example, the second transmission unit 312 acquires the first transmission destination information indicating the first transmission destination R1 from the first DB server device 2 via the second AP server device 5. Then, the second transmission unit 312 transmits the second data D2 to the first transmission destination R1 based on the first transmission destination information.

For example, when the first transmission destination R1 is the PC 4, the first transmission destination information is a mail address of the PC 4. Then, the second transmission unit 312 transmits the second data D2 to the PC 4, for example, using an attached file of an e-mail.

The third transmission unit 313 transmits the personal information of the first user U1 to a second transmission destination R2 included in the first area AR1 based on second transmission destination information received from the second AP server device 5. The second transmission destination information indicates the second transmission destination R2.

The second transmission destination R2 is, for example, a smartphone (not shown) owned by the first user U1. In this case, the second transmission destination information is, for example, a mail address of the smartphone owned by the first user U1. Then, the third transmission unit 313 transmits the personal information of the first user U1 to the smartphone (not shown) owned by the first user U1, for example, using an attached file of an e-mail.

Next, the configuration of the PC 4 will be described.

The PC 4 is a personal computer owned by the first user U1. The PC 4 is communicably connected to a keyboard, a mouse, or the like (not shown), and receives an operation from the first user U1. Then, based on the accepted operation, the PC 4 performs, for example, processing of requesting user registration to the first AP server device 1.

The PC 4 includes a fourth control unit 41. The fourth control unit 41 controls each unit of the PC 4. The fourth control unit 41 includes a fourth processor 41A and a fourth memory 41B.

The fourth memory 41B is a storage device that stores a program to be executed by the fourth processor 41A and data in a nonvolatile manner. The fourth memory 41B includes a magnetic storage device, a semiconductor storage element such as a flash ROM, or a nonvolatile storage device of another type. The fourth memory 41B may include a RAM constituting a work area of the fourth processor 41A. The fourth memory 41B stores data to be processed by the fourth control unit 41, a fourth control program PG4 to be executed by the fourth processor 41A, and the like.

The fourth processor 41A may be implemented by a single processor, or a plurality of processors may function as the fourth processor 41A. The fourth processor 41A executes the fourth control program PG4 to control each unit of the PC 4.

The fourth processor 41A may be implemented by an SoC integrated with part or all of the fourth memory 41B and other circuits. The fourth processor 41A may include a combination of a CPU executing a program and a DSP executing predetermined arithmetic processing. All of the functions of the fourth processor 41A may be implemented in hardware or may be implemented using a programmable device.

In the following description, a case will be described in which the fourth processor 41A reads out and executes the fourth control program PG4 stored in the fourth memory 41B to control each unit of the PC 4.

The fourth control unit 41 requests the first AP server device 1 to perform user registration for the first user U1.

Processing of the user registration will be further described with reference to FIG. 2.

After the user registration in the first AP server device 1 is completed, the fourth control unit 41 can receive various services from the first AP server device 1 when personal authentication by the first AP server device 1 is successful.

The personal authentication by the first AP server device 1 will be further described with reference to FIG. 3.

Next, the configuration of the second AP server device 5 will be described.

In the present embodiment, the second AP server device 5 functions as a gateway device for transmitting and receiving data to and from the second DB device 6.

For example, when the first PJ 3 causes the second DB device 6 to store the first data D1 in association with the specific correspondence information DP, the first PJ 3 and the second AP server device 5 execute the following processing. First, the first PJ 3 transmits, to the second AP server device 5, the first data D1, the specific correspondence information DP, and information requesting the second DB device 6 to store the first data DI in association with the specific correspondence information DP. When receiving the request, the second AP server device 5 causes the second DB device 6 to store the first data DI in association with the specific correspondence information DP.

The second AP server device 5 includes a fifth control unit 51. The fifth control unit 51 controls each unit of the second AP server device 5. The fifth control unit 51 includes a fifth processor 51A and a fifth memory 51B.

The fifth memory 51B is a storage device that stores a program to be executed by the fifth processor 51A and data in a nonvolatile manner. The fifth memory 51B includes a magnetic storage device, a semiconductor storage element such as a flash ROM, or a nonvolatile storage device of another type. The fifth memory 51B may include a RAM constituting a work area of the fifth processor 51A. The fifth memory 51B stores data to be processed by the fifth control unit 51, a fifth control program PG5 to be executed by the fifth processor 51A, and the like.

The fifth processor 51A may be implemented by a single processor, or a plurality of processors may function as the fifth processor 51A. The fifth processor 51A executes the fifth control program PG5 to control each unit of the second AP server device 5.

The fifth processor 51A may be implemented by an SoC integrated with part or all of the fifth memory 51B and other circuits. The fifth processor 51A may include a combination of a CPU executing a program and a DSP executing predetermined arithmetic processing. All of the functions of the fifth processor 51A may be implemented in hardware or may be implemented using a programmable device.

In the following description, a case will be described in which the fifth processor 51A reads out and executes the fifth control program PG5 stored in the fifth memory 51B to control each unit of the second AP server device 5.

For example, in response to a request from the PC 4, the fifth control unit 51 notifies the first PJ 3 of the second transmission destination information indicating the second transmission destination R2 included in the first area AR1.

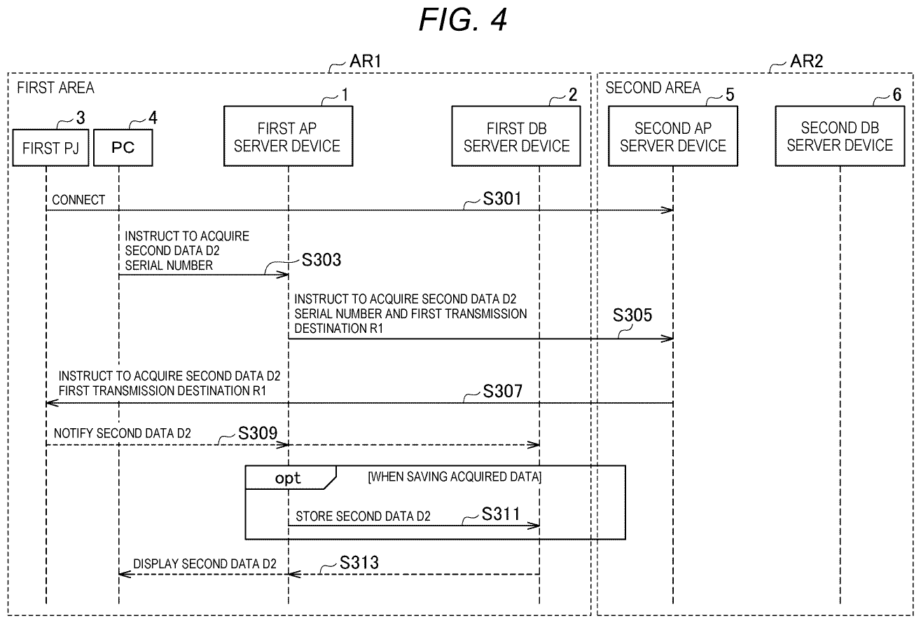

Processing of each device of the data management system 100 in this case will be described in detail with reference to FIG. 4.

Next, the configuration of the second DB server device 6 will be described.

The second DB server device 6 stores the first data D1 in association with the specific correspondence information DP in accordance with an instruction from the second AP server device 5.

The second DB server device 6 includes a sixth control unit 61. The sixth control unit 61 controls each unit of the second DB server device 6. The sixth control unit 61 includes a sixth processor 61A and a sixth memory 61B.

The sixth memory 61B is a storage device that stores a program to be executed by the sixth processor 61A and data in a nonvolatile manner. The sixth memory 61B includes a magnetic storage device, a semiconductor storage element such as a flash ROM, or a nonvolatile storage device of another type. The sixth memory 61B may include a RAM constituting a work area of the sixth processor 61A. The sixth memory 61B stores data to be processed by the sixth control unit 61, a sixth control program PG6 to be executed by the sixth processor 61A, and the like.

The sixth processor 61A may be implemented by a single processor, or a plurality of processors may function as the sixth processor 61A. The sixth processor 61A executes the sixth control program PG6 to control each unit of the second DB server device 6.

The sixth processor 61A may be implemented by an SoC integrated with part or all of the sixth memory 61B and other circuits. The sixth processor 61A may include a combination of a CPU executing a program and a DSP executing predetermined arithmetic processing. All of the functions of the sixth processor 61A may be implemented in hardware or may be implemented using a programmable device.

In the following description, a case will be described in which the sixth processor 61A reads out and executes the sixth control program PG6 stored in the sixth memory 61B to control each unit of the second DB server device 6.

The sixth control unit 61 stores the first data D1 in the sixth memory 61B in association with the specific correspondence information DP in accordance with the instruction from the second AP server device 5.

The first data DI is data not including the personal information of the first user U1 and indicating a state of the first PJ 3 among the information output by the first PJ 3. The first data D1 includes, for example, data such as a light source usage time, input source resolution, and an error history in the first PJ 3.

Next, the configuration of the second PJ 7 will be described.

The second PJ 7 acquires a projection image from a source device (not shown) and projects the projection image onto a projection surface such as a screen. The second PJ 7 includes a camera (not shown), and takes, by the camera, an image of the projection surface onto which the projection image is projected.

The second PJ 7 includes a seventh control unit 71. The seventh control unit 71 controls each unit of the second PJ 7. The seventh control unit 71 includes a seventh processor 71A and a seventh memory 71B.

The seventh memory 71B is a storage device that stores a program to be executed by the seventh processor 71A and data in a nonvolatile manner. The seventh memory 71B includes a magnetic storage device, a semiconductor storage element such as a flash ROM, or a nonvolatile storage device of another type. The seventh memory 71B may include a RAM constituting a work area of the seventh processor 71A. The seventh memory 71B stores data to be processed by the seventh control unit 71, a seventh control program PG7 to be executed by the seventh processor 71A, and the like.

The seventh processor 71A may be implemented by a single processor, or a plurality of processors may function as the seventh processor 71A. The seventh processor 71A executes the seventh control program PG7 to control each unit of the second PJ 7.

The seventh processor 71A may be implemented by an SoC integrated with part or all of the seventh memory 71B and other circuits. The seventh processor 71A may include a combination of a CPU executing a program and a DSP executing predetermined arithmetic processing. All of the functions of the seventh processor 71A may be implemented in hardware or may be implemented using a programmable device.

In the following description, a case will be described in which the seventh processor 71A reads out and executes the seventh control program PG7 stored in the seventh memory 71B to control each unit of the second PJ 7.

The seventh control unit 71 stores the specific correspondence information DP in the seventh memory 71B. The specific correspondence information DP is, for example, identification information associated with both the first PJ 3 and the second PJ 7.

The specific correspondence information DP is identification information for identifying a corporation such as a stock company or an individual that owns the first PJ3. Accordingly, for example, a corporation, such as a stock company, or an individual that owns the second PJ 7 is the same as a corporation such as a stock company or an individual that owns the first PJ 3. In other words, for example, one corporation or one individual owns the first PJ 3 and the second PJ 7.

The seventh control unit 71 transmits third data D3 and the specific correspondence information DP to the second DB server device 6.

The third data D3 is data not including personal information of a second user U2 and indicating a state of the second PJ 7 among information output by the second PJ 7. The second user U2 is a user who owns or uses the second PJ 7. The third data D3 includes, for example, data such as a light source usage time, input source resolution, and an error history in the second PJ 7.

For example, the seventh control unit 71 causes the second DB server device 6 via the second AP server device 5 to store the third data D 3 and the specific correspondence information DP in association with each other.

In this case, first, the seventh control unit 71 transmits, to the second AP server device 5, the third data D3, the specific correspondence information DP, and information requesting the second DB server device 6 to store the third data D3 and the specific correspondence information DP in association with each other. In response to the request, the second AP server device 5 causes the second DB server device 6 to store the third data D3 received from the second PJ 7 and the specific correspondence information DP received from the second PJ 7 in association with each other. Further, the second DB server device 6 stores the third data D3 and the specific correspondence information DP in association with each other in accordance with the instruction from the second AP server device 5.

Next, a sequence of the user registration in the first AP server device 1 will be described with reference to FIG. 2. FIG. 2 is a diagram showing an example of the sequence of the user registration by the first user U1 in the first AP server device 1.

As shown in FIG. 2, first, in step S101, in response to an operation of the first user U1 on the PC 4, the PC 4 requests the first AP server device 1 to register the first user U1 as an owner or user of the first PJ 3. At this time, the PC 4 transmits a user ID and a password to the first AP server device 1.

When the specific correspondence information DP corresponding to the owner of the first PJ 3 owned or used by the first user U1 is already determined, the PC 4 transmits the specific correspondence information DP to the first AP server device 1.

The case in which the specific correspondence information DP corresponding to the owner of the first PJ 3 is already determined is, for example, the following case. That is, the owner of the first PJ 3, for example, a corporation such as a stock company owns a plurality of projectors including the first PJ 3. This is the case in which user registration for a user who owns or uses a projector other than the first PJ 3 among the plurality of projectors is already completed in the first AP server device 1.

Next, in step S103, the storage instruction unit 111 of the first AP server device 1 causes the first DB server device 2 to store the user ID and the password as the personal information of the first user U1 in association with the specific correspondence information DP. When the specific correspondence information DP corresponding to the owner of the first PJ 3 is not determined, the first control unit 11 of the first AP server device 1 generates a random number and assigns the generated random number as the specific correspondence information DP corresponding to the owner of the first PJ 3.

Next, in step S105, the first AP server device 1 notifies the PC 4 that the user registration is completed. At this time, the first AP server device 1 notifies the PC 4 of the specific correspondence information DP.

Next, in step S107, the PC 4 causes the first PJ 3 to store the specific correspondence information DP.

Next, in step S109, the first transmission unit 311 of the first PJ 3 transmits the specific correspondence information DP, the first data D1, and a serial number NS of the first PJ 3 to the second DB server device 6 via the second AP server device 5. The serial number NS of the first PJ 3 is a serial number capable of identifying the first PJ 3 and is, for example, a manufacturing number.

Processing in step S109 is executed each time the first data D1 is generated or updated.

The second DB server device 6 receives the specific correspondence information DP, the first data D1, and the serial number NS of the first PJ 3, and stores the specific correspondence information DP, the first data D1, and the serial number NS of the first PJ3 in the sixth memory 61B. Thereafter, the processing ends.

In this manner, the first data D1 of the first PJ 3 is stored in the second DB server device 6 in association with the specific correspondence information DP and the serial number NS of the first PJ 3.

When the serial number NS of the first PJ 3 is stipulated as personal information under the law regarding protection of personal information in the first area AR1, the first PJ 3 encrypts the serial number NS of the first PJ 3 and transmits the encrypted serial number NS to the second DB server device 6. An encryption key used for encryption of the serial number NS of the first PJ 3 is generated by the first AP server device 1 and stored in the first DB server device 2. The encryption key used for encryption of the serial number NS of the first PJ 3 is transmitted from the first AP server device 1 to the first PJ 3 via the PC 4.

Next, a sequence in which the PC 4 displays the first data D1 will be described with reference to FIG. 3. FIG. 3 is a diagram showing an example of the sequence in which the PC 4 displays the first data D1.

As shown in FIG. 3, first, in step S201, the PC4 requests the first AP server device 1 to log in the first user U1 and to transmit the first data D1 in response to the operation of the first user U1 on the PC 4. At this time, the PC 4 transmits the user ID and the password to the first AP server device 1

Next, in step S203, the first AP server device 1 executes authentication processing of the first user U1. In the following description, a case will be described in which authentication of the first user U1 by the first AP server device 1 is successful.

In response to the request from the PC 4, the first acquisition unit 112 of the first AP server device 1 executes processing in the following step S205, step S209, step S217, and step S225 in order to transmit the first data D1 to the PC 4.

Next, in step S205, the first acquisition unit 112 of the first AP server device 1 transmits the user ID of the first user U1 to the first DB server device 2, and requests the specific correspondence information DP corresponding to the user ID.

Next, in step S207, the first DB server device 2 transmits the specific correspondence information DP to the first AP server device 1.

Next, in step S209, the first acquisition unit 112 of the first AP server device 1 transmits the specific correspondence information DP to the second AP server device 5, and requests the serial number NS of the first PJ 3. The serial number NS of the first PJ 3 is stored in a projector list PL of the second DB server device 6. The projector list PL is stored in the second DB server device 6.

The projector list PL is a list that associates the serial numbers NS of a projector owned by a corporation such as a stock company or an individual that corresponds to the specific correspondence information DP with the specific correspondence information DP. In the following description, the projector list PL may be referred to as “PJ list PL” for convenience.

Next, in step S211, in response to a request from the first AP server device 1, the second AP server device 5 transmits the specific correspondence information DP to the second DB server device 6, and requests the serial number NS of the first PJ 3.

Next, in step S213, the second DB server device 6 transmits the serial number NS of the first PJ 3 to the second AP server device 5 in response to a request from the second AP server device 5.

Next, in step S215, the second AP server device 5 transmits the serial number NS of the first PJ 3 to the first AP server device 1 in response to the request from the first AP server device 1.

Next, in step S217, the first acquisition unit 112 of the first AP server device 1 transmits the serial number NS of the first PJ 3 to the second AP server device 5, and requests the first data DI of the first PJ 3.

Next, in step S219, in response to the request from the first AP server device 1, the second AP server device 5 transmits the serial number NS of the first PJ 3 to the second DB server device 6, and requests the first data D1 of the first PJ 3.

Next, in step S221, the second DB server device 6 transmits the first data D1 of the first PJ 3 to the second AP server device 5 in response to the request from the second AP server device 5.

Next, in step S223, the second AP server device 5 transmits the first data DI of the first PJ 3 to the first AP server device 1 in response to the request from the first AP server device 1.

Next, in step S225, the first acquisition unit 112 of the first AP server device 1 transmits the first data D1 of the first PJ 3 to the PC 4, and a display of the PC 4 displays the first data D1. Thereafter, the processing ends.

In this manner, the first user U1 can acquire the first data D1 of the first PJ 3 from the second DB server device 6 disposed in the second area AR2 by operating the PC 4.

When the serial number NS of the first PJ3 is stipulated as personal information under the law regarding protection of personal information in the first area AR1, the serial number NS of the first PJ 3 in FIG. 3 may be replaced with an “encrypted serial number” as necessary, as described with reference to FIG. 2.

Next, a sequence in which the PC 4 acquires the second data D2 will be described with reference to FIG. 4. FIG. 4 is a diagram illustrating an example of the sequence in which the PC4 acquires the second data D2. In FIG. 4, a case will be described in which the PC 4 is already logged in to the first AP server device 1.

First, in step S301, the first PJ 3 is communicably connected to the second AP server device 5 in accordance with the Web Socket standard, for example.

Next, in step S303, the PC 4 transmits the serial number NS of the first PJ 3 to the first AP server device 1, and requests the first AP server device 1 to transmit the second data D2 of the first PJ 3 to the first transmission destination R1. The first transmission destination R1 is, for example, the PC 4.

Next, in step S305, the first AP server device 1 transmits the serial number NS of the first PJ 3 to the second AP server device 5, and requests the second AP server device 5 to transmit the first transmission destination information indicating the first transmission destination R1 to the first PJ 3.

Next, in step S307, the second AP server device 5 transmits the first transmission destination information indicating the first transmission destination R1 to the first PJ 3 in response to the request from the first AP server device 1.

Next, in step S309, the second transmission unit 312 of the first PJ 3 transmits the second data D2 of the first PJ 3 to the first AP server device 1, and requests the first AP server device 1 to transmit the second data D2 of the first PJ 3 to the first transmission destination R1.

Next, in step S311, the first AP server device 1 causes the first DB server device 2 to store the second data D2 of the first PJ 3 in association with the specific correspondence information DP.

Next, in step S313, the first AP server device 1 transmits the second data D2 of the first PJ 3 to the PC 4 as the first transmission destination R1, and the display of the PC 4 displays the second data D2 of the first PJ 3. Thereafter, the processing ends.

In this manner, the first user U1 can acquire the second data D2 of the first PJ 3 by operating the PC 4.

In FIG. 4, the case is described in which the first AP server device 1 causes the first DB server device 2 to store the second data D2 of the first PJ 3 in association with the specific correspondence information DP, but the embodiment is not limited thereto. The first AP server device 1 may acquire the second data D2 of the first PJ 3 from the first DB server device 2.

Next, the information output by the electronic device will be described with reference to FIG. 5. FIG. 5 is a chart showing an example of the information output by the electronic device. In the present embodiment, the case is described in which the “electronic device” is a projector, but the embodiment is not limited thereto. The “electronic device” may be, for example, a printer. The “electronic device” may be, for example, a smart watch. The “electronic device” includes a “first electronic device” and a “second electronic device”.

As shown in FIG. 5, the information output by the electronic device includes data DD that is not personal information, data DJ that is personal information, and data DM that may be personal information. The data DD is included in the first data D1. The data DJ is included in the second data D2. The data DM may be included in the first data D1 or included in the second data D2.

When the “electronic device” is a projector, the data DD includes a light source usage time, an intake air temperature, input source resolution, and an error history. The data DJ includes a mail address of the projector. The data DM includes a projected image and an image taken by a camera.

For example, when the image taken by a camera includes an image of the first user U1, the image taken by a camera is included in the second data D2.

When the “electronic device” is a printer, the data DD includes the number of printed sheets, a remaining amount of ink, and an error history. The data DJ includes a mail address of the printer. The data DM includes printing data.

When the printing data includes, for example, personal information such as a name of the first user U1, the printing data is included in the second data D2.

When the “electronic device” is a smart watch, the data DD includes a communication volume, a CPU load, and a memory usage. The data DJ includes position data of the smart watch and activity amount data of a user. The activity amount data of a user includes data on the number of steps taken by a user and data on a heart rate of a user. The data DM includes photo data and audio data.

For example, when the photo data includes an image of the first user U1, the photo data is included in the second data D2.

### Present Embodiment and Action Effects

As described above with reference to FIGS. 1 to 5, the data management method according to the present embodiment includes: the first application server device 1 disposed in the first area AR1 causing the first database server device 2 disposed in the first area ARI to store the personal information of the first user U1 who resides in the first area AR1 and the specific correspondence information DP, which is associated with the first projector 3 owned by the first user U1, in association with each other; the first projector 3 storing the specific correspondence information DP; the first projector 3 transmitting, to the second database server device 6 disposed in the second area AR2 different from the first area AR1, the specific correspondence information DP and the first data D1 which is data not including personal information of the first user U1 and indicating a state of the first projector 3 among information output by the first projector 3; the second database server device 6 storing the first data D1 and the specific correspondence information DP in association with each other; and the first application server device 1 acquiring the first data D1 from the second database server device 6 using the specific correspondence information DP.

That is, the second database server device 6 disposed in the second area AR2 stores the first data D1 and the specific correspondence information DP in association with each other, and the first application server device 1 disposed in the first area AR1 acquires the first data D1 from the second database server device 6 using the specific correspondence information DP. Here, the first data D1 is data not including the personal information of the first user U1 and indicating the state of the first projector 3 among the information output by the first projector 3.

Therefore, the first application server device 1 disposed in the first area ARI can acquire the first data D1 among the information output by the first projector 3 from the second database server device 6 disposed in the second area AR2. Therefore, the first data D1 among the information output by the first projector 3 can be subjected to data crossing border.

In other words, when the first projector 3 transmits the first data D1 to the second database server device 6, the first data DI can be subjected to data crossing border from the first area AR1 to the second area AR2. When the first application server device 1 acquires the first data D1 from the second database server device 6, the first data D1 can be subjected to data crossing border from the second area AR2 to the first area AR1.

In the data management method, the first projector 3 is disposed in the first area AR1, and the data management method includes: the first application server device 1 acquiring, from the first projector 3, the second data D2 which is data excluding the first data D1 and including the personal information of the first user U1 among the information output by the first projector 3.

Accordingly, the first projector 3 is disposed in the first area AR1, and the first application server device 1 acquires the second data D2 from the first projector 3. Here, the second data D2 which is data excluding the first data D1 and including the personal information of the first user U1 among the information output by the first projector 3. Therefore, since the first application server device 1 acquires the second data D2 from the first projector 3 disposed in the first area AR1, data crossing border of data including personal information can be prevented. In other words, the data crossing border of the second data D2 including the personal information of the first user U1 who resides in the first area AR1 can be prevented.

The data management method includes: the first application server device 1 associating the second data D2 with the specific correspondence information DP and transmitting the second data D2 to the first database server device 2; and the first application server device 1 causing the first database server device 2 to store the second data D2 in association with the specific correspondence information DP.

Accordingly, the first application server device 1 disposed in the first area AR1 causes the first database server device 2 disposed in the first area AR1 to store the second data D2 from the first projector 3 disposed in the first area AR1 in association with the specific correspondence information DP. Therefore, since the second data D2 is stored in the first database server device 2 disposed in the first area AR1, the data crossing border of data including personal information can be prevented. In other words, the data crossing border of the second data D2 including the personal information of the first user U1 who resides in the first area AR1 can be prevented.

The data management method includes: the first application server device 1 causing the first database server device 2 to store the first transmission destination information indicating the first transmission destination R1 which is a transmission destination to which the first projector 3 transmits the second data D2 and included in the first area AR1; and the first projector 3 transmitting the second data D2 to the first transmission destination R1 based on the first transmission destination information acquired from the first database server device 2.

Accordingly, the first projector 3 transmits the second data D2 to the first transmission destination R1 included the first area ARI based on the first transmission destination information acquired from the first database server device 2. Therefore, in the first area AR1, the first projector 3 can easily transmit the second data D2 to the first transmission destination R1.

The data management method includes: a second application server device 5 disposed in the second area AR2 notifying the first projector 3 of the second transmission destination information indicating the second transmission destination R2 included in the first area AR1; and the first projector 3 transmitting the personal information of the first user U1 to the second transmission destination R2 based on the second transmission destination information.

Accordingly, the first projector 3 transmits, based on the second transmission destination information notified from the second application server device 5, the personal information of the first user U1 to the second transmission destination R2 included in the first area AR1. In the first area AR1, the first projector 3 can easily transmit the personal information of the first user U1 to the second transmission destination R2.

In the data management method, the specific correspondence information DP is identification information associated with both the first projector 3 and at least the second projector 7 different from the first projector 3, the second user U2 different from the first user U1 owns the second projector 7, and the data management method includes: the second projector 7 storing the specific correspondence information DP; the second projector 7 transmitting, to the second database server device 6, the specific correspondence information DP and the third data D3 which is data not including the personal information of the second user U2 and indicating a state of the second projector 7 among information output by the second projector 7; and the second database server device 6 storing the third data D3 and the specific correspondence information DP in association with each other.

That is, the second database server device 6 stores the third data D3 and the specific correspondence information DP in association with each other. Here, the third data D3 is data not including the personal information of the second user U2 and indicating the state of the second projector 7 among the information output by the second projector 7. The specific correspondence information DP is identification information associated with both the first projector 3 and the second projector 7 different from the first projector 3. Accordingly, the second database server device 6 can store the first data D1 from the first projector 3 and the third data D3 from the second projector 7 in association with one piece of specific correspondence information DP. When a corporation such as a stock company or an individual owns a plurality of projectors including the first projector 3 and the second projector 7, owner information can be easily managed by using the specific correspondence information DP.

The data management method includes: the first application server device 1 transmitting, when the first application server device 1 successfully authenticates the first user U1 from the personal computer 4 disposed in the first area AR1 and owned by the first user U1, the first data D1 and the personal information of the first user U1 to the personal computer 4.

Accordingly, the first application server device 1 transmits the first data D1 and the personal information of the first user U1 to the personal computer 4 disposed in the first area AR1 and owned by the first user U1. Therefore, in the first area AR1, the personal computer 4 owned by the first user U1 can easily acquire the first data D1 and the personal information of the first user U1.

In the data management method, the second data D2 includes at least a part of setting information of the first projector 3.

Therefore, since the second data D2 includes at least a part of the setting information of the first projector 3, the second data D2 can be set in accordance with the law regarding protection of personal information in the first area AR1. Therefore, the second data D2 can be appropriately set.

In the data management method, the second data D2 includes at least a part of image information of the first projector 3.

Therefore, since the second data D2 includes at least a part of the image information of the first projector 3, the second data D2 can be set in accordance with the law regarding protection of personal information in the first area AR1. Therefore, the second data D2 can be appropriately set.

The data management system 100 according to the present embodiment includes: the first database server device 2 disposed in the first area AR1 and configured to store the personal information of the first user U1 who resides in the first area AR1 and the specific correspondence information DP, which is associated with the first projector 3 owned by the first user U1, in association with each other; the second database server device 6 disposed in the second area AR2 different from the first area AR1 and configured to store the specific correspondence information DP and the first data D1 in association with each other, the first data D1 being data not including the personal information of the first user U1 and indicating the state of the first projector 3 among the information output by the first projector 3; and the first application server device 1 configured to acquire the first data D1 from the second database server device 6 using the specific correspondence information DP.

Therefore, the data management system 100 according to the present embodiment can achieve the same effects as the data management method according to the present embodiment.

### Other Embodiments

The present embodiment described above is a preferred embodiment. However, the present disclosure is not limited to the embodiment described above, and various modifications are possible without departing from the gist of the present disclosure.

In the present embodiment, the case is described in which the data management system 100 includes the first AP server device 1 and the first DB server device 2, but the embodiment is not limited thereto. For example, the first AP server device 1 and the first DB server device 2 may be implemented as one server device. In this case, a configuration of the data management system 100 can be simplified.

In the present embodiment, the case is described in which the data management system 100 includes the second AP server device 5 and the second DB server device 6, but the embodiment is not limited thereto. The second AP server device 5 and the second DB server device 6 may be implemented as one server device, for example. In this case, the configuration of the data management system 100 can be simplified.

In the present embodiment, the case is described in which the “association data” is the specific correspondence information DP, but the embodiment is not limited thereto. The “association data” may be data associated with the first PJ 3 and may be information that does not correspond to personal information of a user such as the first user U1.

The “association data” may be, for example, encrypted data. The “association data” may be, for example, data in which the serial number NS of the first PJ 3 is encrypted.

In the present embodiment, the case is described in which the first control unit 11 generates the random number corresponding to the specific correspondence information DP, but the embodiment is not limited thereto. The random number corresponding to the specific correspondence information DP may be generated by any one of the first AP server device 1, the first DB server device 2, the first PJ 3, the PC 4, the second AP server device 5, the second DB server device 6, and the second PJ 7. For example, when the first DB server device 2 generates the random number corresponding to the specific correspondence information DP, in step S103 shown in FIG. 2, the first DB server device 2 may transmit the random number corresponding to the specific correspondence information DP in response to a request from the first AP server device 1.

In the present embodiment, the case is described in which the “first file server device” is the first database server device 2 and the “second file server device” is the second database server device 6, but the embodiment is not limited thereto. The “first file server device” and the “second file server device” may be implemented to be capable of storing various types of data.

In the present embodiment, the case is described in which the “first electronic device” and the “second electronic device” are a projector, but the embodiment is not limited thereto. The “first electronic device” and the “second electronic device” may be, for example, a printer. The “first electronic device” and the “second electronic device” may be, for example, a smart watch.

In the present embodiment, the case will be described in which the “terminal device” is the personal computer 4, but the embodiment is not limited thereto. The “terminal device” may be, for example, a tablet terminal. The “terminal device” may be, for example, a smartphone.

In the present embodiment, the case is described in which the second PJ 7 is disposed in the second area AR2, but the embodiment is not limited thereto. For example, the second PJ 7 may be disposed in the first area AR1. The second PJ 7 may be disposed in a third area different from the first area AR1 and the second area AR2.

The functional units shown in FIG. 1 indicate functional components. Specific implementation forms of the functional units are not particularly limited. That is, hardware individually corresponding to the functional units does not always need to be implemented. It is also possible to adopt a configuration in which one processor executes programs to implement functions of a plurality of functional units. Further, part of the functions implemented by software in the above-described embodiment may be implemented by hardware or part of the functions implemented by hardware may be implemented by software. In addition, the specific detailed configurations of each unit of the first application server device 1, the first database server device 2, the first projector 3, the personal computer 4, the second application server device 5, the second database server device 6, and the second projector 7 can be changed as desired without departing from the spirit of the disclosure.

The processing units of the sequences shown in FIGS. 2 to 4 are divided according to main processing contents in order to facilitate understanding of the processing of the first control unit 11 to the sixth control unit 61. The processing units can also be divided into a larger number of processing units according to processing contents without being limited by a way and a name of division of the processing unit shown in the sequences shown in FIGS. 2 to 4 and can also be divided such that one processing unit includes a larger number of kinds of processing. The processing order of the above sequence is not limited to those of the illustrated examples.

The data management method can be implemented by the first processor 11A to the seventh processor 71A executing the following processing. That is, the first processor 11A reads out and executes the first control program PG1 stored in the first memory 11B. The second processor 21A reads out and executes the second control program PG2 stored in the second memory 21B. The third processor 31A reads out and executes the third control program PG3 stored in the third memory 31B. The fourth processor 41A reads out and executes the fourth control program PG4 stored in the fourth memory 41B. The fifth processor 51A reads out and executes the fifth control program PG5 stored in the fifth memory 51B. The sixth processor 61A reads out and executes the sixth control program PG6 stored in the sixth memory 61B. The seventh processor 71A reads out and executes the seventh control program PG7 stored in the seventh memory 71B.

Each of the first control program PG1 to the seventh control program PG7 can be recorded on a computer-readable recording medium.

A magnetic or optical recording medium or a semiconductor memory device can be used as the recording medium. Specific examples of the recording medium include a portable or stationary recording medium such as a flexible disc, an HDD, a compact disk read only memory (CD-ROM), a DVD, a Blu-ray (registered trademark) Disc, a magneto-optical disc, a flash memory, and a card type recording medium. The recording medium may be a non-volatile storage device such as RAM, ROM, or HDD, which is an internal storage device provided in each of the first application server device 1, the first database server device 2, the first projector 3, the personal computer 4, the second application server device 5, the second database server device 6, and the second projector 7.

### Appendixes

The present disclosure will be summarized below as additional remarks.

(Appendix 1) A data management method including:
a first application server device disposed in a first region causing a first file server device disposed in the first region to store personal information of a first user who resides in the first region and association data, which is associated with a first electronic device owned by the first user, in association with each other;
the first electronic device storing the association data;
the first electronic device transmitting, to a second file server device disposed in a second region different from the first region, the association data and first data which is data not including the personal information of the first user and indicating a state of the first electronic device among information output by the first electronic device;
the second file server device storing the first data and the association data in association with each other; and
the first application server device acquiring the first data from the second file server device using the association data.

Accordingly, the second file server device disposed in the second region stores the first data and the association data in association with each other, and the first application server device disposed in the first region acquires the first data from the second file server device using the association data. Here, the first data is data not including the personal information of the first user who resides in the first region and indicating the state of the first electronic device among the information output by the first electronic device.

Therefore, the first application server device disposed in the first region can obtain the first data among the information output by the first electronic device from the second file server device disposed in the second region. Therefore, the first data among the information output by the first electronic device can be subjected to data crossing border.

In other words, when the first electronic device transmits the first data to the second file server device, the first data can be subjected to data crossing border from the first region to the second region. When the first application server device acquires the first data from the second file server device, the first data can be subjected to data crossing border from the second region to the first region.

(Appendix 2) The data management method according to Appendix 1, in which
the first electronic device is disposed in the first region, and
the data management method further includes: the first application server device acquiring, from the first electronic device, second data which is data excluding the first data and including the personal information of the first user among the information output by the first electronic device.

Accordingly, the first electronic device is disposed in the first region, and the first application server device acquires the second data from the first electronic device. Here, the second data is data excluding the first data and including the personal information of the first user among the information output by the first electronic device. Therefore, since the first application server device acquires the second data from the first electronic device disposed in the first region, data crossing border of data including personal information can be prevented. In other words, the data crossing border of the second data including the personal information of the first user who resides in the first region can be prevented.

(Appendix 3) The data management method according to Appendix 2, further including:
the first application server device associating the second data with the association data and transmitting the second data to the first file server device; and
the first application server device causing the first file server device to store the second data in association with the association data.

Accordingly, the first application server device disposed in the first region causes the first file server device disposed in the first region to store the second data of the first electronic device disposed in the first region in association with the association data. Therefore, since the second data is stored in the first file server device disposed in the first region, the data crossing border of data including personal information can be prevented. In other words, the data crossing border of the second data including the personal information of the first user who resides in the first region can be prevented.

(Appendix 4) The data management method according to Appendix 3, further including:
the first application server device causing the first file server device to store first transmission destination information indicating a first transmission destination which is a transmission destination to which the first electronic device transmits the second data and included in the first region; and
the first electronic device transmitting the second data to the first transmission destination based on the first transmission destination information acquired from the first file server device.

Accordingly, the first electronic device transmits, based on the first transmission destination information acquired from the first file server device, the second data to the first transmission destination included in the first region. Therefore, in the first region, the first electronic device can easily transmit the second data to the first transmission destination.

(Appendix 5) The data management method according to any one of Appendixes 1 to 4, further including:
a second application server device disposed in the second region notifying the first electronic device of second transmission destination information indicating a second transmission destination included in the first region; and
the first electronic device transmitting the personal information of the first user to the second transmission destination based on the second transmission destination information.

Accordingly, the first electronic device transmits, based on the second transmission destination information notified from the second application server device, the personal information of the first user to the second transmission destination included in the first region. Therefore, in the first region, the first electronic device can easily transmit the personal information of the first user to the second transmission destination.

(Appendix 6) The data management method according to any one of Appendixes 1 to 5, in which
the association data includes identification information associated with both the first electronic device and at least a second electronic device different from the first electronic device,
the second electronic device is owned by a second user different from the first user,
the second electronic device stores the association data, and
the data management method further includes:
   the second electronic device transmitting, to the second file server device, the association data and third data which is data not including personal information of the second user and indicating a state of the second electronic device among information output by the second electronic device; and
   the second file server device storing the third data and the association data in association with each other.

Accordingly, the second file server device stores the third data and the association data in association with each other. Here, the third data is data not including the personal information of the second user and indicating the state of the second electronic device among the information output by the second electronic device. The association data includes identification information associated with both the first electronic device and the second electronic device different from the first electronic device. Accordingly, the second file server device can store the first data of the first electronic device and the third data of the second electronic device in association with one piece of association data. Therefore, when a corporation such as a stock company or an individual owns a plurality of electronic devices including the first electronic device and the second electronic device, owner information can be easily managed by using the association data.

(Appendix 7) The data management method according to any one of Appendixes 1 to 6, further including:
the first application server device transmitting, when the first application server device successfully authenticates the first user from a terminal device disposed in the first region and owned by the first user, the first data and the personal information of the first user to the terminal device.

Accordingly, the first application server device transmits the first data and the personal information of the first user to the terminal device disposed in the first region and owned by the first user. Therefore, in the first region, the terminal device owned by the first user can easily acquire the first data and the personal information of the first user.

(Appendix 8) The data management method according to any one of Appendixes 2 to 4, in which
the second data includes at least a part of setting information of the first electronic device.

Accordingly, since the second data includes at least a part of the setting information of the first electronic device, the second data can be set in accordance with the law regarding protection of personal information in the first region. Therefore, the second data can be appropriately set.

(Appendix 9) The data management method according to any one of Appendixes 2 to 4, in which
the second data includes at least a part of image information of the first electronic device.

Accordingly, since the second data includes at least a part of the image information of the first electronic device, the second data can be set in accordance with the law regarding protection of personal information in the first region. Therefore, the second data can be appropriately set.

(Appendix 10) A data management system including:
a first file server device configured to store personal information of a first user who resides in a first region and association data, which is associated with a first electronic device owned by the first user, in association with each other;
a second file server device disposed in a second region different from the first region and configured to store the association data and first data in association with each other, the first data being data not including the personal information of the first user and indicating a state of the first electronic device among information output by the first electronic device; and
a first application server device configured to acquire the first data from the second file server device using the association data.

Accordingly, the data management system described in Appendix 10 can achieve the same effects as the data management method described in Appendix 1.

What is claimed is:

1. A data management method comprising:
a first application server device disposed in a first region causing a first file server device disposed in the first region to store personal information of a first user who resides in the first region and association data, which is associated with a first electronic device owned by the first user, in association with each other;
the first electronic device storing the association data;
the first electronic device transmitting, to a second file server device disposed in a second region different from the first region, the association data and first data which is data not including the personal information of the first user and indicating a state of the first electronic device among information output by the first electronic device;
the second file server device storing the first data and the association data in association with each other; and
the first application server device acquiring the first data from the second file server device using the association data.

2. The data management method according to claim 1, wherein
the first electronic device is disposed in the first region, and
the data management method further comprises: the first application server device acquiring, from the first electronic device, second data which is data excluding the first data and including the personal information of the first user among the information output by the first electronic device.

3. The data management method according to claim 2, further comprising:
the first application server device associating the second data with the association data and transmitting the second data to the first file server device; and
the first application server device causing the first file server device to store the second data in association with the association data.

4. The data management method according to claim 3, further comprising:
the first application server device causing the first file server device to store first transmission destination information indicating a first transmission destination which is a transmission destination to which the first electronic device transmits the second data and included in the first region; and
the first electronic device transmitting the second data to the first transmission destination based on the first transmission destination information acquired from the first file server device.

5. The data management method according to claim 1, further comprising:
a second application server device disposed in the second region notifying the first electronic device of second transmission destination information indicating a second transmission destination included in the first region; and
the first electronic device transmitting the personal information of the first user to the second transmission destination based on the second transmission destination information.

6. The data management method according to claim 1, wherein
the association data includes identification information associated with both the first electronic device and at least a second electronic device different from the first electronic device,
the second electronic device is owned by a second user different from the first user,
the second electronic device stores the association data, and
the data management method further comprises:
the second electronic device transmitting, to the second file server device, the association data and third data which is data not including personal information of the second user and indicating a state of the second electronic device among information output by the second electronic device; and
the second file server device storing the third data and the association data in association with each other.

7. The data management method according to claim 1, further comprising:
the first application server device transmitting, when the first application server device successfully authenticates the first user from a terminal device disposed in the first region and owned by the first user, the first data and the personal information of the first user to the terminal device.

8. The data management method according to claim 2, wherein
the second data includes at least a part of setting information of the first electronic device.

9. The data management method according to claim 2, wherein
the second data includes at least a part of image information of the first electronic device.

10. A data management system comprising:
a first file server device configured to store personal information of a first user who resides in a first region and association data, which is associated with a first electronic device owned by the first user, in association with each other;
a second file server device disposed in a second region different from the first region and configured to store the association data and first data in association with each other, the first data being data not including the personal information of the first user and indicating a state of the first electronic device among information output by the first electronic device; and
a first application server device configured to acquire the first data from the second file server device using the association data.
